(19) United States
(12) Patent Application Publication
(10) Pub. No.: US 2022/0300882 A1
(43) Pub. Date: Sep. 22, 2022

(54) Apparatus For Animated Three-Dimensional Data Visualization

(71) Applicant: iViz Group, Inc. DBA iDashboards, Troy, MI (US)

(72) Inventor: Shadan Akhtar Malik, Orlando, FL (US)

(73) Assignee: iViz Group, Inc. DBA iDashboards, Troy, MI (US)

(21) Appl. No.: 17/655,456

(22) Filed: Mar. 18, 2022

Related U.S. Application Data
(60) Provisional application No. 63/163,496, filed on Mar. 19, 2021.

(51) Int. Cl. G06Q 10/06; G06Q 30/00; G06T 13/20; G06F 16/25; G06F 16/904

(52) U.S. Cl. CPC G06Q 10/06393; G06Q 30/01; G06T 13/20; G06F 16/252; G06F 16/904

(57) ABSTRACT

An apparatus for generating a three-dimensional object for data visualization is described. The apparatus comprising a user interface module, an extraction module, a search catalog module, and a visual presentation module. The user interface is configured to receive a chart input from a user. The extraction module is configured to extract at least one characteristic from the chart input. The search catalog module is configured to retrieve a plurality of charts based on the at least one characteristic from the chart input. The visual presentation module is configured to generate the three-dimensional object including the plurality of charts. The user interface module is configured to present the three-dimensional object to the user.

### CROSS-REFERENCE TO RELATED APPLICATIONS

This application claims priority to and all the advantages of U.S. Provisional Patent Application No. 63/163,496, filed on Mar. 19, 2021, the contents of which are incorporated herein by reference.

### TECHNICAL FIELD

United States Patent Classification Primary Class/Subclass 345/418 (COMPUTER GRAPHICS PROCESSING AND SELECTIVE VISUAL DISPLAY SYSTEMS—wherein data is displayed to a user for visual viewing (e.g., control of the form of the data on a CRT, monitor, screen, display device, or any generic visual output device).

Systems and methods of the present invention relate to three-dimensional data visualization for generating a three-dimensional object including multiple charts and/or graphs.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Charts are an extremely effective way to communicate and visualize data. Organizations often track business metrics by way of key performance indicators (KPIs) which are often presented to the user on one or more dashboards including a number of charts. The dashboard brings the most important KPIs together in one place for quick and effective data visualization and analysis. KPIs may be presented in the form of bar charts (horizontal or vertical), pie charts, scatterplots, line trend charts, bubble charts, etc. The type of chart may be selected in a manner to optimize the way to improve data visualization and user recognition of data relationships. KPIs often overlap and influence each other. Displaying KPIs alongside one another assists the user in recognizing patterns and trends among the KPIs.

Dashboards that are cluttered with too many charts make it difficult for the user to visualize and recognize trends in the data which undermines the purpose of the dashboard. Dashboards that do not display enough charts or graphs do not provide the user with enough data to understand the inter-dependencies among the KPIs of the organization at a quick glance.

### SUMMARY

In a feature, an apparatus for generating a three-dimensional object for data visualization is described. The apparatus including a user interface module, an extraction module, a search catalog module, and a visual presentation module. The user interface module is configured to receive a chart input from a user. The extraction module is configured to extract at least one characteristic from the chart input. The search catalog module is configured to retrieve a plurality of charts based on the at least one characteristic from the chart input. The visual presentation module is configured to generate the three-dimensional object including the plurality of charts. The user interface module is configured to present the three-dimensional object to the user.

In further features, the visual presentation module is configured to animate the three-dimensional object.

In further features, the visual presentation module is configured to select a shape of the three-dimensional object based on a number of the plurality of charts.

In further features, the visual presentation module is configured to display each chart of the plurality of charts on a face of the three-dimensional object.

In further features, the shape is selected from a predefined list of shapes based on a number of charts retrieved and based on a number of faces of the shape.

In further features, the user interface module is configured to receive user input associated with the three-dimensional object.

In further features, in response to the user input corresponding to a selection of one of the plurality of charts of the three-dimensional object, other charts associated with faces of the three-dimensional object that were not selected are switched from a first illumination state to a second illumination state, the first illumination state and the second illumination state being visually distinguishable.

In further features, in response to the user input indicating a selection of the one of the plurality of charts of the three-dimensional object, the chart is brought to a forefront of the three-dimensional object.

In further features, the user input is a position signal associated with a user input device, the position signal being used to determine a cursor position.

In further features, the visual presentation module is configured to: rotate the three dimensional object in a first direction in response to (i) actuation of the user input device, (ii) the cursor position corresponding to a portion of the three-dimensional object, and (iii) the position signal indicting the user input device is moving in the first direction; and rotate the three-dimensional object in a second direction in response to (i) actuation of the user input device, (ii) the cursor position corresponding to the portion of the three-dimensional object, and (iii) the position signal indicting the user input device is moving in the second direction.

In further features, the visual presentation module is configured to determine a rate of change in the position signal and in response to the rate of change, adjust a speed of rotation based on the rate of change in the position signal.

In further features, the at least one characteristic corresponds to at least one variable associated with the chart input.

In further features, the at least one characteristic corresponds to a title of the chart input.

In further features, the at least one characteristic corresponds to a label for an axis of the chart input.

In further features, the search catalog module is configured to retrieve the plurality of charts based on the at least one characteristic extracted from the chart input from a data source.

In further features, the search catalog module is configured to: retrieve a data set associated with the chart input from at least one of a web application, a customer relationship management (CRM) application, and an enterprise resource planning system; generate a new chart associated with the data set; and store the new chart that has been generated in a database.

In further features, the search catalog module is configured to retrieve the plurality of charts using a matching algorithm.

In further features, the visual presentation module is configured to include the chart input on a face of the three-dimensional object.

In further features, a shape of the three-dimensional object is selected based on a type of at least one chart of the plurality of charts.

In further features, the plurality of charts is further defined as a second plurality of charts, the user interface module is further configured to generate a dashboard including a first plurality of charts, the chart input is selected from one of the first plurality of charts displayed on the dashboard, each chart of the second plurality of charts being associated with a key performance indicator (KPI).

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of a computing environment for a dashboard system according to the teachings of the present disclosure.

FIG. 2 shows a diagrammatic representation of a machine in the example form of a computer system according to the teachings of the present disclosure.

FIG. 3 is a functional block diagram of the dashboard system according to the teachings of the present disclosure.

FIGS. 4A and 4B are examples of a dashboard graphical user interface (GUI) according to the teachings of the present disclosure.

FIGS. 5A and 5B are examples of a three-dimensional object according to the teachings of the present disclosure.

FIG. 6 is a functional block diagram of a visual presentation module according to the teachings of the present disclosure.

FIG. 7 is an example of a three-dimensional object according to the teachings of the present disclosure.

FIG. 8 is an example of a three-dimensional object showing user-interaction according to the teachings of the present disclosure.

FIG. 9 is an example of an enlarged chart contained within a three-dimensional object generated according to the teachings of the present disclosure.

### DETAILED DESCRIPTION

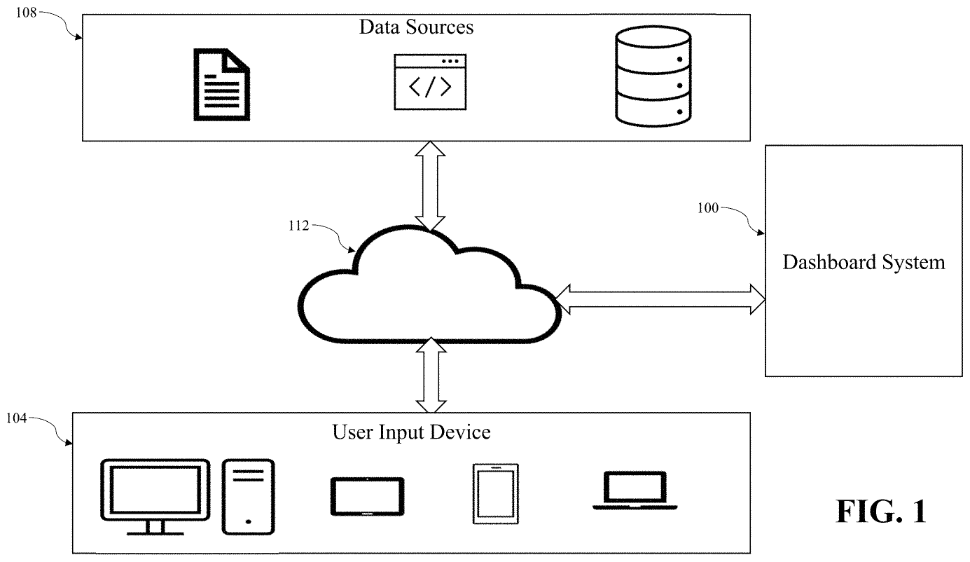

FIG. 1 is a functional block diagram illustrating an example environment including a dashboard system 100 configured to generate a dashboard GUI including various charts to display key performance indicators (KPIs). The dashboard system 100 may communicate with the user input devices 104 and data sources 108 via the network 112.

The example environment illustrated in FIG. 1 includes a user input device 104. The user input device 104 may include any computing device that is capable of communicating with the dashboard system 100. A user input device 104 may include, but is not limited to, smart phones, tablet computers, laptop computers, and desktop computers, as illustrated in FIG. 1. A user input device 104 may also include other computing devices having other form factors, such as computing device included in a vehicle, gaming device, television, touchscreen monitor, etc.

The user input device 104 may use a variety of different operating systems. In an example where the user input device 104 is a mobile device, the user input device 104 may run an operating system including, but not limited to, ANDROID, iOS developed by Apple Inc., or WINDOWS PHONE developed by Microsoft Corporation. In an example where a user device 104 is a laptop or desktop device, the user input device 104 may run an operating system including, but not limited to, MICROSOFT WINDOWS, MAC OS, or Linux (e.g., RED HAT LINUX). The user input device 104 may also access the dashboard system 100 while running operating systems other than those operating systems described above, whether presently available or developed in the future.

The user input device 104 running an application may communicate with the dashboard system 100 via the network 112. The application may take one of a number of forms, running in a browser or as an application, including user interfaces, dashboard interfaces, engagement consoles, and other interfaces, such as mobile interfaces, tablet interfaces, summary interfaces, etc. The application may be hosted on a cloud-based environment, on such an environment is described in U.S. Pat. No. 10,296,192, the contents which is herein incorporated by reference in its entirety. The application may also be hosted by a web-based server in an on-premise environment. In one implementation, an application can be accessed from a browser running on a computing device. The browser can be Chrome, Internet Explorer, Firefox, Safari, Opera, and the like. In other implementations, an application may run as an engagement console on a computer desktop application. The application that is run by the user input device 104 to communicate with the dashboard system 100 may display a dashboard graphical user interface (GUI) with representative KPIs on the user input device 104. The user may interact with the dashboard GUI in various ways as will be discussed in greater detail below.

FIG. 1 shows data sources 108 which provide data to the dashboard system 100. The dashboard system 100 uses the data to generate and update the dashboard GUI. For example, the dashboard system 100 may generate charts based on data retrieved from the data sources 108. The data sources 108 may include a variety of different data providers. The data sources 108 may include data from a customer relationship management (CRM) application, entity resource planning (ERP) application, a human resource management system, an accounting system, a financial management system, intellectual property management system, a web application, a manufacturing process management system, a server, a data warehouse, a database, a cloud-based data source such as Amazon Cloud or Microsoft Azure, etc. The data sources 108 may provide data to the dashboard system 100 continuously, once every predetermined period (e.g., every 30 minutes), or upon request from the dashboard system 100.

As described above, the user input device 104, the dashboard system 100, data sources 108 may be in communication with one another via the network 112. The network 112 may include various types of networks, such as a wide area network (WAN), the Internet, and/or a local area network (LAN). The network 112 is any suitable system for connecting communications between these various systems, and may use any standard or non-standard communication technologies and/or protocols.

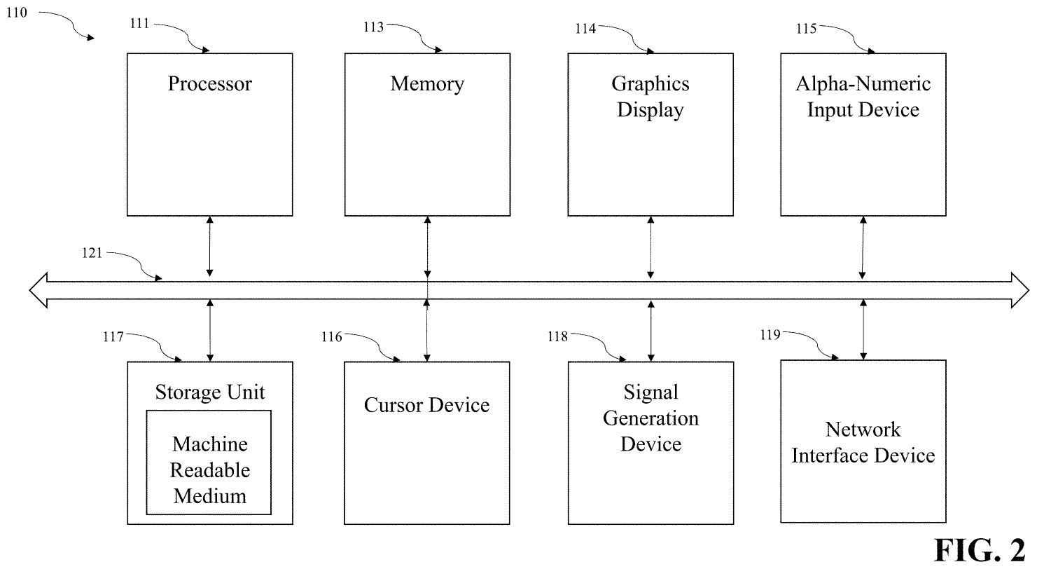

FIG. 2 is a functional block diagram illustrating components of an example machine able to read instructions from a machine-readable medium and execute them in a processor (or controller), as an example of the dashboard system 100 or user input device 104. Specifically, FIG. 2 shows a diagrammatic representation of a machine in the example form of a computer system 110 within which instructions (e.g., software/applications) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The example computer system 110 includes one or more processors 111 (e.g., a central processing unit (CPU), a graphics processing unit (GPU), a digital signal processor (DSP), one or more application specific integrated circuits (ASICs), one or more radio-frequency integrated circuits (RFICs), or any combination of these), memory 113 (main and static memory), which are configured to communicate with each other via a bus 121.

The computer system 110 may further include graphics display unit 114 (e.g., a plasma display panel (PDP), a liquid crystal display (LCD), a projector, or a cathode ray tube (CRT)). The computer system 110 may also include an alphanumeric input device 115 (e.g., a keyboard), a cursor device 116 (e.g., a mouse, a trackball, a joystick, a motion sensor, or other pointing instrument), a storage unit 117, a signal generation device 118 (e.g., a speaker), and a network interface device 119, which also are configured to communicate via the bus 121.

The storage unit 117 includes a machine-readable medium on which is stored instructions (e.g., software) embodying any one or more of the methodologies or functions described herein. The instructions (e.g., software) may also reside, completely or at least partially, within the memory 113 or within the processor 111 (e.g., within a processor's cache memory) during execution thereof by the computer system 110, the memory 113 and the processor 111 also constituting machine-readable media. The instructions (e.g., software) may be transmitted or received over a network 112 via the network interface device 119.

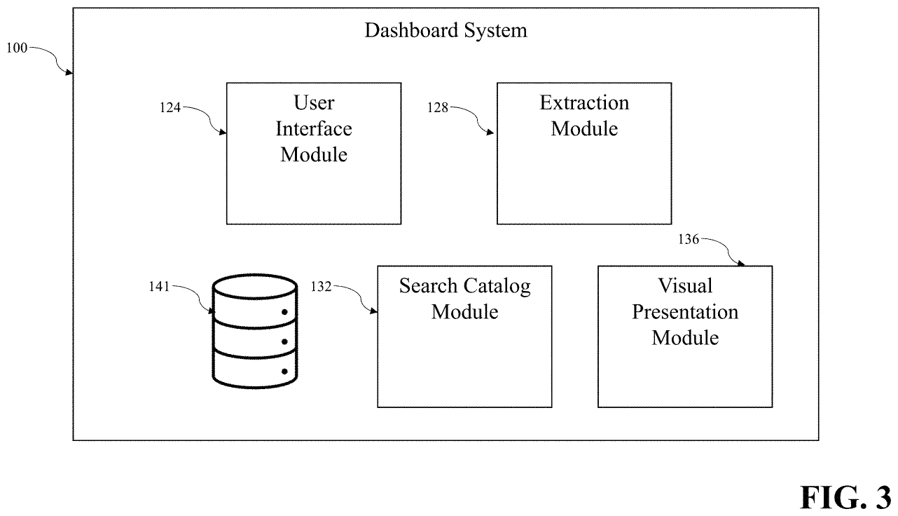

With reference to FIG. 3, a functional block diagram of the dashboard system 100 is shown. The dashboard system 100 includes various components and modules for performing the functions and methods as described herewith. The dashboard system 100 includes a user interface module 124, an extraction module 128, a search catalog module 132, a visual presentation module 136, and one or more databases 141.

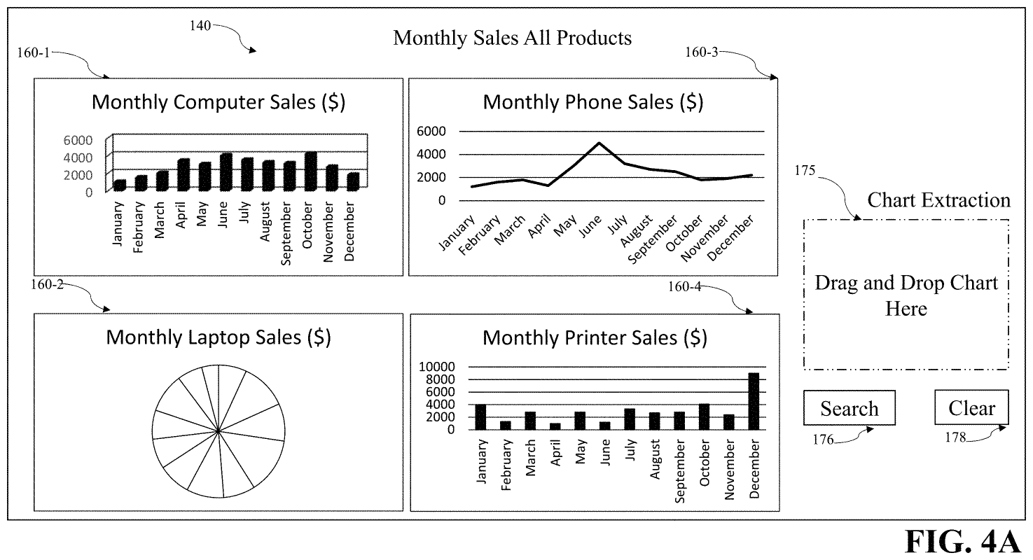

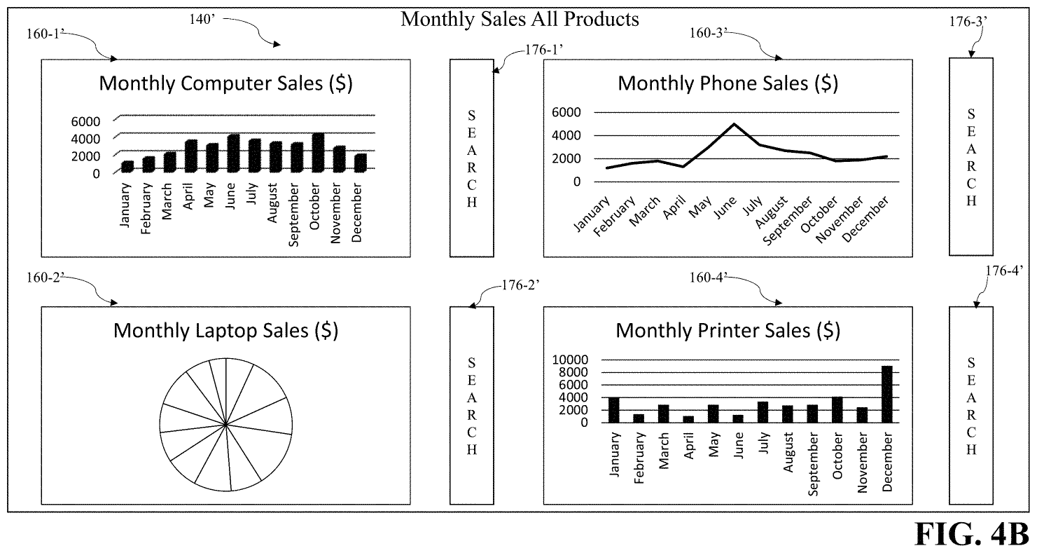

With additional reference to FIG. 4A, the user interface module 124 presents a dashboard GUI 140 to the user at the user input device 104. The dashboard GUI 140 presented to the user may include a plurality of charts 160-1, 160-2, 160-3, 160-4 (collectively 160) with each chart 160 being representative of a KPI. The user may interact with any one of the plurality of charts 160 as the user desires. The user may select a portion (by placing a cursor pointer over the portion) of any of the charts 160 to highlight the corresponding portion of the chart 160 with respect to the deselected portions. The user may click a portion of the chart 160 (e.g., a bar of bar chart 160-1) to gather further insight on the data associated with that particular portion of the chart 160. If the user were to click the January bar of chart 160-1, the dashboard GUI 140 may then display the data associated with January computer sales, for example, a table showing the total sales per sales representative for the month of January. This user experience is referred to as drilldown.

With any KPI, there may be a variety of measurable metrics that impact the performance of the KPI. For example, manufacturing, advertising, marketing, and other metrics may impact sales of a company or sales of any given product. Thus, there exists a need for a dashboard system 100 that allows a user to retrieve any and all relevant metrics associated with a KPI. There further exists a need for an efficient way of presenting the retrieved metrics to a user without crowding the dashboard GUI 140.

The various modules, such as the search catalog module 132, may be configured to communicate with one or more data sources 108 via an application program interface (API) using the network 112. The search catalog module 132 may obtain various data sets or charts associated with KPIs of the dashboard GUI 140 from the database 141 or one of the data sources 108. When a data set obtained by the search catalog module 132 does not have a corresponding chart, the search catalog module 132 may generate an associated chart and store the chart in the database 141. The search catalog module 132 may be configured to determine an optimal chart type for the dataset to ensure the dataset is displayed in an optimal way. The search catalog module 132 may update the data sets and/or charts associated with the KPIs, continuously or once every predetermined period (e.g., every 10 minutes) to ensure the most up-to-date data is being provided to the user. The predetermined period may be adjustable and configurable by the user of the dashboard GUI 140.

In an example, when one of the KPIs corresponds to monthly gross sales of computers as shown in chart 160-1, the search catalog module 132 may retrieve datasets and/or charts associated with monthly marketing of computers, monthly inventory of computers, monthly sales per representative, manufacturing of computers, and other metrics associated with computers. In a further example, the data sources 108 provided the inventory dataset without a corresponding chart. As such, the search catalog module 132 determined a line chart would best convey the inventory data set and thus generated a line chart based on the inventory dataset and stored the chart in the database 141.

The dashboard GUI 140 presented by the user interface module 124 allows for the user to trigger a metric-based search based on any one of the charts 160 of the dashboard GUI 140 by submitting a chart extraction request. As shown in FIG. 4A, the user may drag and drop one or more of the charts 160 into the chart extraction framework 175. The search may begin when the user clicks the search button 176. With reference back to FIG. 2, in response to the chart extraction request received via the user input device 104, the extraction module 128 may be configured to extract at least one characteristic associated with a chart received via the chart extraction request.

The extraction module 128 may extract the at least one characteristic using any suitable extraction method. The at least one characteristic may correspond to a title of the chart, a label for an axis of the chart (i.e., a label for the y-axis and/or a level for the x-axis), and/or any other characteristic that may be able to identify the chart. The extraction module 128 may extract the at least one characteristic using data parsing and reading the attributes of the chart. While the example is provided, another suitable extraction method may be used. Based on the chart extraction request, the search catalog module 132 may be configured to query the database 141 to retrieve all charts associated with the at least one characteristic. The search catalog module 132 may retrieve all charts associated with the at least one characteristic by performing iterative searches with respect to the at least one characteristic. Based on the retrieved charts, the visual presentation module 136 may be configured to generate a three-dimensional object 180 including the retrieved charts. The visual presentation module 136 may also be configured to generate one or more charts/graphs for display based on a user selection of one of a plurality of charts of a three-dimensional object 140.

With reference to FIG. 4B, an alternative configuration of the dashboard GUI 140′ is shown. The dashboard GUI 140′ functions substantially similar to the dashboard GUI 140 so a detailed discussion of each component is hereby omitted. Instead this paragraph focuses on the differences between the dashboard GUI 140′ and the dashboard GUI 140. Instead of the chart extraction framework 175, search buttons 176-1′, 176-2′, 176-3′, 176-4′ are presented next to each chart 160-1′, 160-2′, 160-3′ and 160-4′. Instead of dragging a respective chart into the chart extraction framework 175 to initiate the search, the user engages the associated search button 176-1′, 176-2′, 176-3′, 176-4′ positioned next to each of the charts.

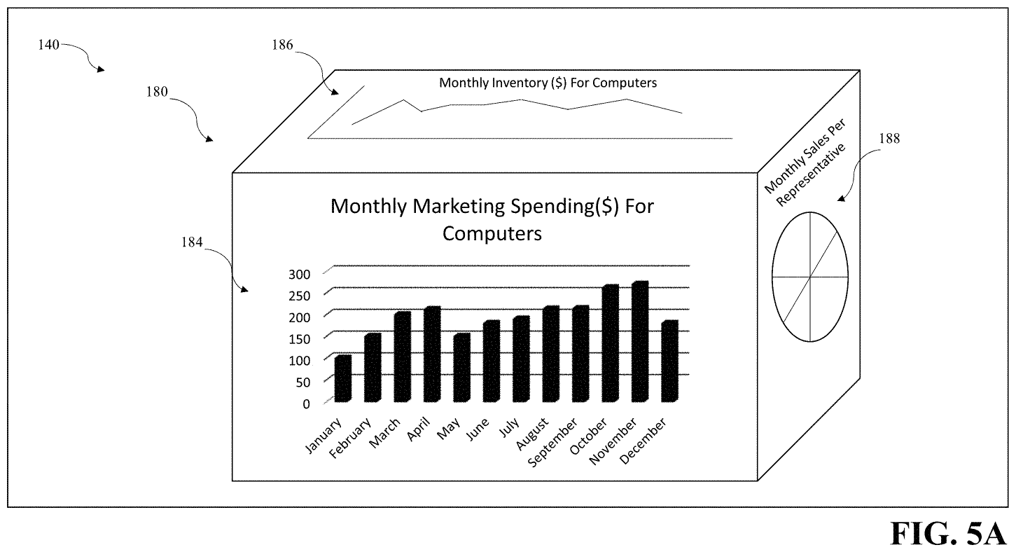

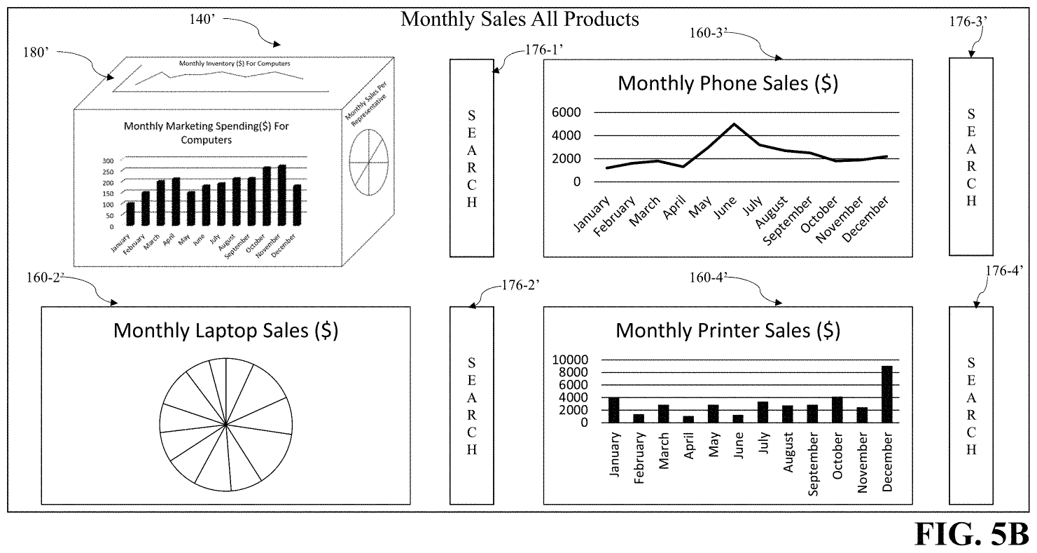

With reference to FIGS. 5A and 5B, based on the retrieved charts, the visual presentation module 136 may be configured to generate a three-dimensional object 180 including the retrieved charts. In a first configuration, as shown in FIG. 5A, the dashboard GUI 140 generates the three-dimensional object 180 on a second screen or window and charts associated with a first screen of the dashboard GUI 140 may no longer be visible. In a second configuration, as shown in FIG. 5B, the dashboard GUI 140′ replaces the initial chart or chart that triggered the search with the three-dimensional object 180 such that the three-dimensional object 180 may be viewed with respect the initial charts. When a number of the plurality of the retrieved charts is less than the number of faces of the three-dimensional object 180, the other faces of the three-dimensional object may remain blank suggesting no other matching metrics were found in the search.

In the illustrated examples of FIGS. 5A and 5B, the chart extraction request is based on the monthly computer sales ($) chart 160-1 of the dashboard GUI 140. As shown in the illustrated example, the retrieved charts correspond to a monthly marketing spending ($) for computers chart 184, a monthly inventory ($) for computers chart 186, and a monthly sales ($) per representative for computers chart 188.

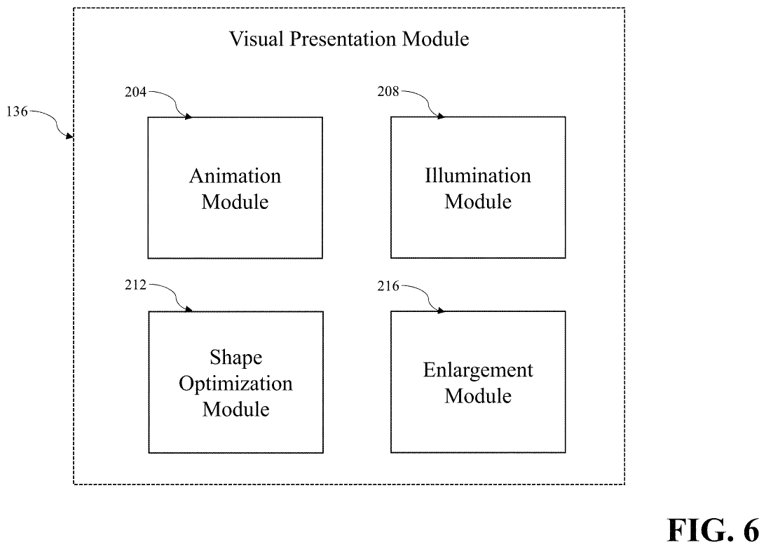

With additional reference to FIG. 6, the visual presentation module 136 may include an animation module 204, an illumination module 208, and a shape optimization module 212. The shape optimization module 212 may be configured to determine a shape of the three-dimensional object 180 based on a number of the retrieved charts or a type of the retrieved charts. In an example, when the number of retrieved charts is six, the shape optimization module 212 may select hexahedron, such as a cube or pentagonal pyramid, as the shape of the three-dimensional object 180. The shape optimization module 212 may select a shape for the three-dimensional object 180 based on a number of faces of the shape such that at most one of the retrieved charts is displayed on each face of the three-dimensional object 180.

When the retrieved charts correspond to a particular chart type, the shape optimization module 212 may determine that the visual appearance of the three-dimensional object 180 will be optimized if a particular shape for the three-dimensional object 180 is chosen. For example, when the retrieved charts include one or more pie charts, the shape optimization module 212 may select a cube over the pentagonal pyramid to ensure that the pie chart is not distorted when displayed on a face of the three-dimensional object 180.

The illumination module 208 may be configured to determine an illumination state for each face of the three-dimensional object 180. The illumination module 208 may initially set each face of the three-dimensional object 180 to a first illumination state (IS1). When a face is set to the first illumination state IS1, the face appears lit up. In response to receiving user input via a cursor device 116, the illumination module 208 may switch the illumination state of one or more of the faces of the three-dimensional object 180. When the user positions the cursor pointer over a particular face of the three-dimensional object 180 without selecting the particular face, the illumination module 208 may switch faces in which the cursor pointer is not currently positioned overtop of the first illumination state (IS1) to a second illumination state (IS2). In the second illumination state (IS2), the faces may appear dimmer. When the cursor pointer is not positioned overtop of any portion of the three-dimensional object 180, the illumination module 208 sets each face of the three-dimensional object 180 to the first illumination state (IS1).

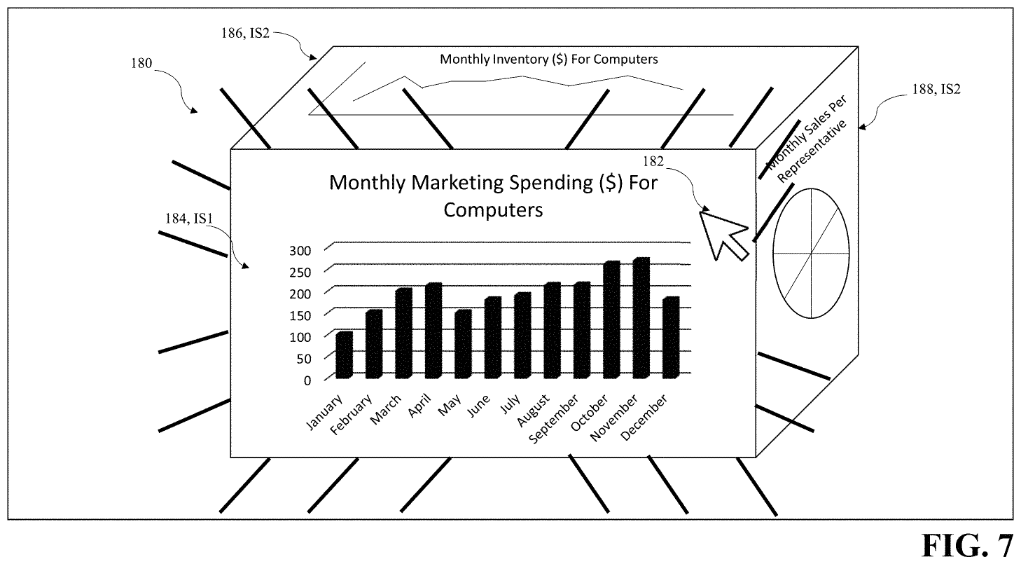

With reference to FIG. 7, in the illustrated embodiment, the cursor pointer 182 is positioned overtop of the face including the monthly marketing spending ($) for computers chart 184. As such, the illumination module 208 switches the remaining faces, that is, the faces including the monthly inventory ($) for computers chart 186, and the monthly sales ($) per representative for computers chart 188 from the first illumination state (IS1) to the second illumination state (IS2).

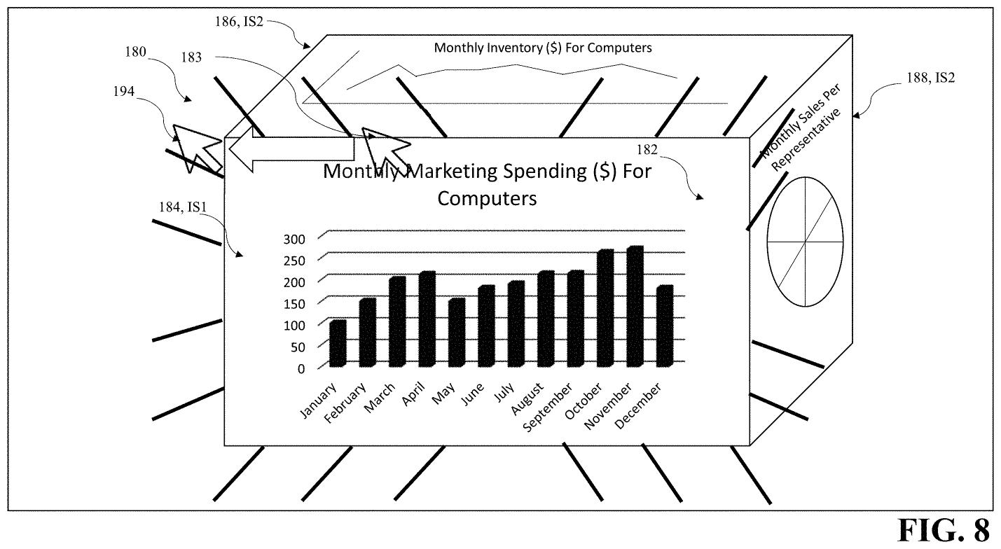

With reference to FIG. 8, the animation module 204 may be configured to determine a default animated sequence for the three-dimensional object 180. The default animated sequence may be based on one or more predetermined animation rules. The predetermined rules may include a default rate at which the three-dimensional object 180 is rotated on the dashboard GUI 140, and a default rotation direction to rotate the three-dimensional object 180 on the dashboard GUI 140. The animation module 204 may be configured to receive a position signal associated with a cursor device 116 of the user input device 104.

The animation module 204 may be configured to alter the animation sequence based on the position signal associated with the cursor device 116. The animation module 204 may be configured to determine a rate of change in the position signal and alter the animation sequence based on the rate of change in the position signal. In the illustrated embodiment, when the user clicks and holds the cursor pointer over one of the faces at a first position 183 of the three-dimensional object 180 and slowly drags the cursor pointer 182 to a second position 194, the animation module 204 may alter the animation sequence. The animation module 204 renders updates to the user interface module 124 based on the altered animation sequence such that the three-dimensional object 180 is rotated in the direction in which the cursor pointer 182 moved from the first (183) to the second (194) position and proportional to the rate of change in the position signal.

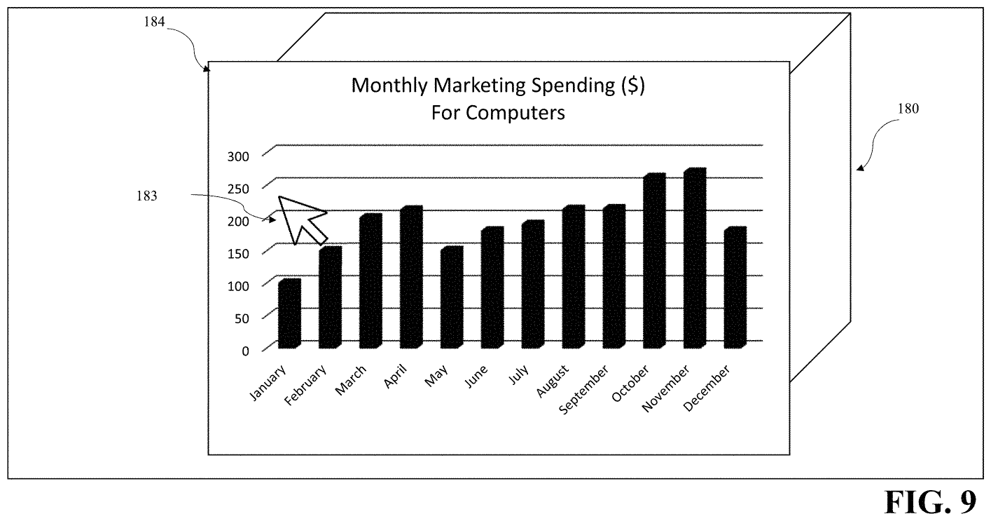

With reference to FIG. 9, an enlargement module 216 may be configured to bring a chart to the forefront of the three-dimensional object 180 in response to user input. For example, the enlargement module 216 may be configured to enlarge and overlay a chart over the three-dimensional object 180 in response to user input such as when the user positions the cursor pointer 182 over one of the charts of the three-dimensional object 180 then clicks and releases an input of the cursor device 116 while maintaining the position of the cursor device 116 (i.e., maintaining the position of the cursor pointer 182 with respect to the chart).

While the disclosure contemplates performing a search/extraction based on a chart input, the methods and system of this disclosure could be extended to other types of inputs and other forms of outputs. An image input may be provided to the user interface module 124 and the three-dimensional object 180 may display a combination of charts 160, images, and other types of data types. For example, a collection of headshot images for a sales team could be displayed on the dashboard GUI 140 with each image being labeled by a first and last name. The user may select (e.g., drag and drop or click on an image) one of the images (i.e., the headshots) to perform a search on.

The search catalog module 132 could retrieve one or more metrics associated with the selected image. For example, the three-dimensional object 180 could include all metrics (sales dollars, attendance, relative team rank, calls made, percent win ratio, leads created, etc.) associated with the team member whose headshot was selected. In another example, the user may select multiple images, such as all the headshots of the sales team. As a result, the three-dimensional object 180 may display a combination of images and charts that are representative of the metrics of the team as a whole.

Clause 1—A method for facilitating data visualization comprising: receiving a chart input from a user; extracting at least one characteristic from the chart input; retrieving a plurality of charts based on the at least one characteristic from the chart; and generating a three-dimensional object including the plurality of charts.

Clause 2—A non-transitory computer-readable medium storing processor-executable instructions for facilitating data visualization, the instructions comprising: receiving a chart input from a user; extracting at least one characteristic from the chart input; retrieving a plurality of charts based on the at least one characteristic from the chart; and generating a three-dimensional object including the plurality of charts.

Clause 3—An apparatus for data visualization, the apparatus comprising a visual presentation module configured to generate a three-dimensional object including a plurality of charts; a user interface module configured to: present the three-dimensional object to the user and receive a selection of one of the plurality of charts from the user; a search catalog module configured to retrieve key performance indicators based on the selection of one of the plurality of charts; and the user interface module is configured to present the key performance indicators to the user.

Clause 4—An apparatus for data visualization, the apparatus comprising: a visual presentation module configured to generate a three-dimensional object including a plurality of first charts; and a user interface module configured to: present the three-dimensional object to the user; receive a selection of one of the plurality of first charts from the user. wherein the visual presentation module is configured to generate one or more second charts based on the selection of the one of the plurality of first charts; and the user interface module is configured to present the one or more second charts to the user.

Clause 5—An apparatus for data visualization, the apparatus comprising: a visual presentation module configured to generate a three-dimensional object including a plurality of charts; and a user interface module configured to: present the three-dimensional object to the user; receive a selection of one of the plurality of charts from the use, wherein the visual presentation module is configured to generate a dashboard based on the selection of the one of the plurality of charts, wherein the user interface module is configured to present the dashboard to the user.

Clause 6—An apparatus for data visualization, the apparatus comprising: a visual presentation module configured to generate a three-dimensional object including the plurality of charts; and a user interface module configured to present the three-dimensional object to the user and receive a selection of one of the plurality of charts; an extraction module configured to extract at least one characteristic from the selected chart; a search catalog module configured to retrieve a plurality of charts based on the at least one characteristic from the chart; and the visual presentation module is configured to generate a dashboard including the retrieved plurality of charts; and wherein the user interface module is configured to present the dashboard to the user.

Clause 7—An apparatus for data visualization, the apparatus comprising: a visual presentation module configured to generate a three-dimensional object including a plurality of images; and a user interface module configured to present the three-dimensional object to the user and receive a selection of one of the plurality of images; an extraction module configured to extract at least one characteristic from the selected image; a search catalog module configured to retrieve a plurality of charts based on the at least one characteristic from the image; and the visual presentation module is configured to generate a dashboard including the retrieved plurality of charts; and wherein the user interface module is configured to present the dashboard to the user.

Clause 8—An apparatus for data visualization, the apparatus comprising: a visual presentation module configured to generate a three-dimensional object including a plurality of images; and a user interface module configured to present the three-dimensional object to the user and receive a selection of one of the plurality of images; the visual presentation module is configured to generate a dashboard including at least one of a plurality of charts and a plurality of graphs associated with the selected one of the plurality of images; and wherein the user interface module is configured to present the dashboard to the user.

Clause 9—An apparatus for data visualization, the apparatus comprising: a visual presentation module configured to generate a three-dimensional object including a plurality of images; and a user interface module configured to present the three-dimensional object to the user and receive a selection of one of the plurality of images; the visual presentation module is configured to generate at least one metric associated with the selected one of the plurality of images; and wherein the user interface module is configured to present the at least one metric to the user.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the examples is described above as having certain features, any one or more of those features described with respect to any example of the disclosure can be implemented in and/or combined with features of any of the other examples, even if that combination is not explicitly described. In other words, the described examples are not mutually exclusive, and permutations of one or more examples with one another remain within the scope of this disclosure.

Spatial and functional relationships between elements (for example, between controllers, modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “controller” or “module” may be replaced with the term “circuit.” The term “controller” or “module” may refer to, be part of, or include: an Application Specific Integrated Circuit (ASIC); a programmable system on a chip (PSoC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality, such as in a system-on-chip; and a single executable file that contains instructions or a combination of some or all of the above.

Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors, e.g., processor) may be configured by software (e.g., an application or application portion) as a hardware module that operates to perform certain operations as described herein.

The controller and/or module may include one or more interface circuits with one or more transceivers. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The controller or module may communicate with other controllers and/or modules using the interface circuit(s). Although the controller may be depicted in the present disclosure as logically communicating directly with other controllers and/or module, in various implementations the controller may actually communicate via a communications system. The communications system may include physical and/or virtual networking equipment such as hubs, switches, routers, gateways and transceivers. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the controller and/or module may be distributed among multiple controllers and/or modules that are connected via the communications system. For example, multiple controllers and/or multiple modules may implement the same functionality distributed by a load balancing system. In a further example, the functionality of the controller or module may be split between a server (also known as remote, or cloud) controller and/or module and a client (or, user) controller and/or module.

Some or all hardware features of a controller and/or module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a controller and/or module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple controllers and/or modules. The term group processor circuit encompasses a processor circuit that, in combination with additional processor circuits, executes some or all code from one or more controllers and/or modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple controllers and/or modules. The term group memory circuit encompasses a memory circuit that, in combination with additional memories, stores some or all code from one or more controllers and/or modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above may serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. Modules may be incorporated into the computer programs through interfaces.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An apparatus for generating a three-dimensional object for data visualization, the apparatus comprising:
a user interface module configured to receive a chart input from a user;
an extraction module configured to extract at least one characteristic from the chart input;
a search catalog module configured to retrieve a plurality of charts based on the at least one characteristic from the chart input; and
a visual presentation module configured to generate the three-dimensional object including the plurality of charts; and
wherein the user interface module is configured to present the three-dimensional object to the user.

2. The apparatus for generating the three-dimensional object of claim 1, wherein the visual presentation module is configured to animate the three-dimensional object.

3. The apparatus for generating the three-dimensional object of claim 2, wherein the visual presentation module is configured to select a shape of the three-dimensional object based on a number of the plurality of charts.

4. The apparatus for generating the three-dimensional object of claim 3, wherein the visual presentation module is configured to display each chart of the plurality of charts on a face of the three-dimensional object.

5. The apparatus for generating the three-dimensional object of claim 4, wherein the shape is selected from a predefined list of shapes based on a number of charts retrieved and based on a number of faces of the shape.

6. The apparatus for generating the three-dimensional object of claim 4, wherein the user interface module is configured to receive user input associated with the three-dimensional object.

7. The apparatus for generating the three-dimensional object of claim 6, wherein in response to the user input corresponding to a selection of one of the plurality of charts of the three-dimensional object, other charts associated with faces of the three-dimensional object that were not selected are switched from a first illumination state to a second illumination state, the first illumination state and the second illumination state being visually distinguishable.

8. The apparatus for generating the three-dimensional object of claim 6, wherein in response to the user input indicating a selection of the one of the plurality of charts of the three-dimensional object, the chart is brought to a forefront of the three-dimensional object.

9. The apparatus for generating the three-dimensional object of claim 6, wherein the user input is a position signal associated with a user input device, the position signal being used to determine a cursor position.

10. The apparatus for generating the three-dimensional object of claim 9, the visual presentation module is configured to:
rotate the three-dimensional object in a first direction in response to (i) actuation of the user input device, (ii) the cursor position corresponding to a portion of the three-dimensional object, and (iii) the position signal indicting the user input device is moving in the first direction; and
rotate the three-dimensional object in a second direction in response to (i) actuation of the user input device, (ii) the cursor position corresponding to the portion of the three-dimensional object, and (iii) the position signal indicting the user input device is moving in the second direction.

11. The apparatus for generating the three-dimensional object of claim 10, wherein the visual presentation module is configured to determine a rate of change in the position signal and, in response to the rate of change, adjust a speed of rotation based on the rate of change in the position signal.

12. The apparatus for generating the three-dimensional object of claim 1, wherein the at least one characteristic corresponds to at least one variable associated with the chart input.

13. The apparatus for generating the three-dimensional object of claim 1, wherein the at least one characteristic corresponds to a title of the chart input.

14. The apparatus for generating the three-dimensional object of claim 1, wherein the at least one characteristic corresponds to a label for an axis of the chart input.

15. The apparatus for generating the three-dimensional object of claim 1, wherein the search catalog module is configured to retrieve the plurality of charts based on the at least one characteristic extracted from the chart input from a data source.

16. The apparatus for generating the three-dimensional object of claim 1, wherein the search catalog module is configured to:
retrieve a data set associated with the chart input from at least one of a web application, a customer relationship management (CRM) application, and an enterprise resource planning system;
generate a new chart associated with the data set; and
store the new chart that has been generated in a database.

17. The apparatus for generating the three-dimensional object of claim 1, wherein the search catalog module is configured to retrieve the plurality of charts using a matching algorithm.

18. The apparatus for generating the three-dimensional object of claim 1, wherein the visual presentation module is configured to include the chart input on a face of the three-dimensional object.

19. The apparatus for generating the three-dimensional object of claim 1, wherein a shape of the three-dimensional object is selected based on a type of at least one chart of the plurality of charts.

20. The apparatus for generating the three-dimensional object of claim 1, wherein the plurality of charts is further defined as a second plurality of charts, the user interface module is further configured to generate a dashboard including a first plurality of charts, the chart input is selected from one of the first plurality of charts displayed on the dashboard, each chart of the second plurality of charts being associated with a key performance indicator (KPI).
